(19) United States
(12) Patent Application Publication
(10) Pub. No.: US 2007/0271240 A1
(43) Pub. Date: Nov. 22, 2007

(54) METHOD AND SYSTEM OF ACCESSING NETWORK FROM AN EMBEDDED DEVICE

(75) Inventors: Zheng Zhao, Beijing (CN); Tiezhuo Huang, Beijing (CN); Haibo Zhang, Beijing (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: MEDIATEK (BEIJING) INC., Beijing (CN)

(21) Appl. No.: 11/745,645

(22) Filed: May 8, 2007

(30) Foreign Application Priority Data
May 17, 2006 (CN) 200610082567.3

(51) Int. Cl. G06F 17/30

(52) U.S. Cl. 707/3

(57) ABSTRACT

A method of accessing a network from an embedded device is provided. Information is provided, specifying corresponding relationship between at least one category notation and at least one data type. A string is received. At least one keyword is extracted from the string. A category notation is extracted from the string. Addresses of web pages containing the keyword are searched from a database storing the addresses of web pages containing data type corresponding to the category notation.

### CROSS REFERENCE TO RELATED APPLICATIONS

This application claims priority of People's Republic of China Patent Application Ser. No. 200610082567.3, filed May. 17, 2006. The contents of the application are hereby incorporated by reference.

### BACKGROUND

The invention relates to an embedded device, and more particularly to a method and system enabling access to the network from an embedded device.

This section is intended to introduce the reader to various aspects of art, which may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Some embedded devices access the Internet via protocol such as WAP (Wireless Application Protocol). Some, however, consider WAP browsers of embedded devices to be difficult to use. For example, an embedded device with constrained user interface capabilities, such as few buttons, is poor at receiving manual input from a user. Accordingly, when browsing the Internet, input of a web site address or a keyword pertaining to a web page may be difficult.

Conventionally, an ActiveX feature (such as an Active control) installed in a computer-based browser can retrieve a user-defined keyword provided in an address field of a browser. A search operation is then initiated to locate web pages containing the keyword. The ActiveX feature implemented in a computer-based browser, however, cannot be implemented in a resource constrained embedded device. The described keyword search operation can not be realized without modifying the core of a WAP browser.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

A method of accessing a network from an embedded device is provided. Information is provided, specifying corresponding relationship between at least one category notation and at least one data type. A string is received. At least one keyword is extracted from the string. A category notation is extracted from the string. Addresses of web pages containing the keyword are searched from a database storing addresses of web pages containing the data type corresponding to the category notation.

Also provided is an embedded device connecting to a server via a network. A user interface receives a string. A storage unit stores information specifying a corresponding relationship between at least one category notation and at least one data type. A processor extracts at least one keyword from the string and extracts a category notation from the string, wherein addresses of web pages containing the keyword are searched from a database storing addresses of web pages containing the data type corresponding to the category notation.

Also provided is a server providing web search service to an embedded device. An interface receives a string from the embedded device. A storage unit stores information corresponding relationship between at least one category notation and at least one data type. A processor extracts at least one keyword from the string and extracts a category notation from the string, wherein addresses of web pages containing the keyword are searched from a database storing addresses of web pages containing the data type corresponding to the category notation.

### BRIEF DESCRIPTION OF DRAWINGS

The invention can he more fully understood by reading the subsequent detailed description and examples with references made to the accompanying drawings, wherein:

FIG. 1 is a schematic view of an embodiment of a wireless communication system;

FIG. 2 is a schematic view of an embodiment of the embedded device and the WAP server;

FIG. 3 is a schematic view of another embodiment of the embedded device and the WAP server;

FIGS. 4A and 4B show a flowchart of an embodiment of a method of accessing a network from an embedded device; and

FIGS. 5A and 5B illustrate a flowchart of an embodiment of a method of accessing a network from an embedded device.

### DETAILED DESCRIPTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constrains, which may vary from one implementation to another Moreover, it should be appreciated that such a development effort might be complex and time consuming, but would nevertheless be a routine undertaking of design, fabrication, and manufacture for those of ordinary skill having the benefit of this disclosure.

In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

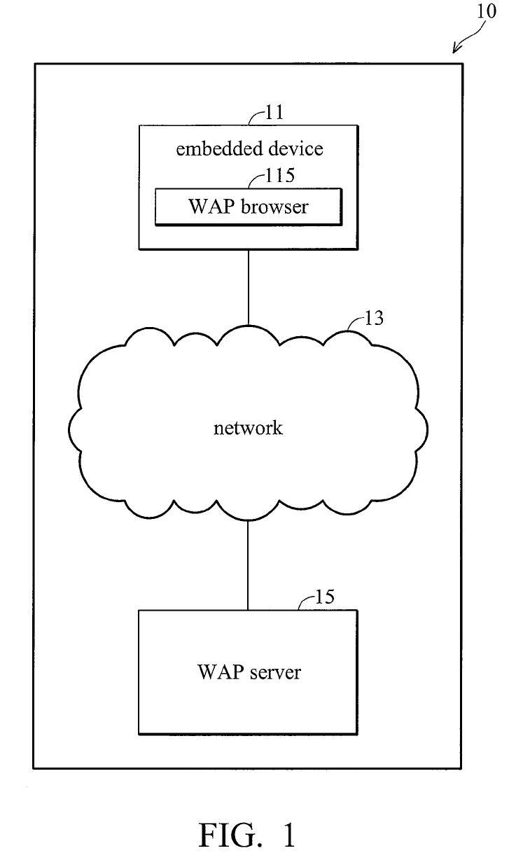

FIG. 1 is a schematic view of an embodiment of a wireless communication system 10, comprising an embedded device 11, a network 13, and a WAP server 15. The embedded device 11 can be a mobile phone, an in-vehicle device or other embedded device. The embedded device 11 accesses the WAP server 15 through the network 13. The network 13 can comprise the Internet, WAP and other network. The network 13 is provided by a service provider. The embedded device 11 comprises a WAP browser 115 capable of receiving input information from a user. The input information can be a string, comprising a character (such as a Chinese character), numbers, symbols, and a combination thereof. The input information is transmitted to the WAP server 15 via the network 13. The WAP server 15 receives the input information, locates a web page according to the input information, and transmits the web page to the embedded device 11 via the network 13.

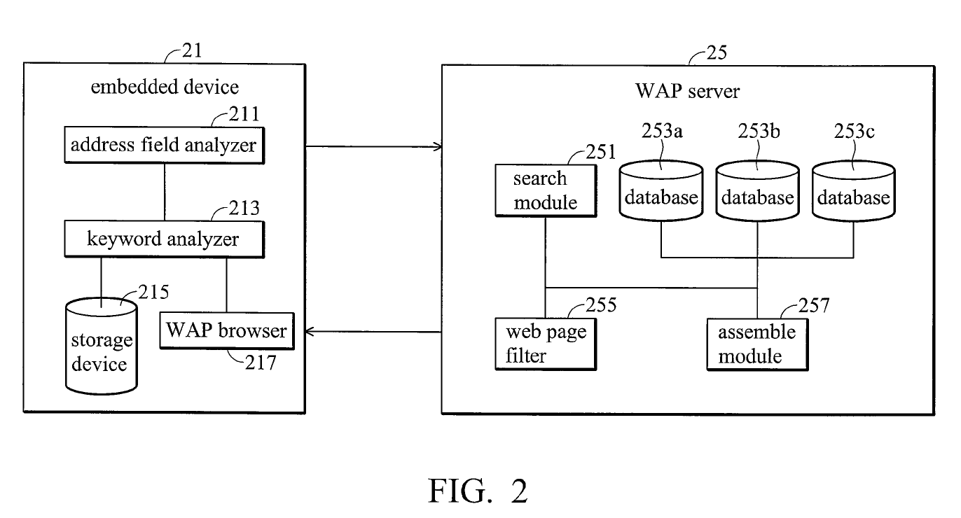

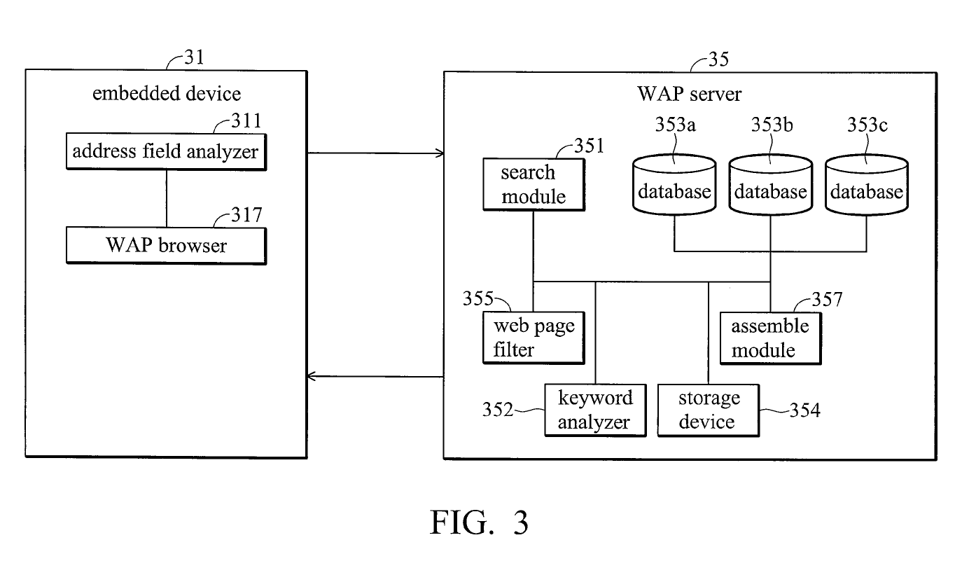

In order to facilitate the searching operation and simplify the manual input operation, the input information can be further processed by either the embedded device 11 or the WAP server 15 before using it to perform a search operation. FIGS. 2 and 3 illustrate two embodiments of the wireless communication system 10.

FIG. 2 is a schematic view of an embodiment of the embedded device and the WAP server, wherein the input information is further processed by the embedded device before using it to perform a search operation. In FIG. 2, network is omitted for simplicity.

In order to further process the input information, an embedded device 21 comprises an address field analyzer 211, a keyword analyzer 213, a storage device 215, and a WAP browser 217. The WAP server 25 comprises a search module 251, databases 253a, 253b, and 253c, web page filter 255, and an assemble module 257.

The address field analyzer 211 analyzes a string input into an address field, wherein the address field is provided by a WAP browser 217 for receiving and presenting an address corresponding to a web page. For example, the address field analyzer 211 determines whether the string comprises a web page address. This can be done by checking whether the string comprises data having a web page address format.

If the string comprises a web page address, the string is transmitted to the WAP server 25. A web page corresponding to the address is retrieved from the network according to the address.

The storage device 215 stores information specifying a corresponding relationship between a category notation and a data type. For example, the storage device 215 stores a table specifying a plurality of category notations, each of which corresponds to the database (such as the databases 253a, 253b, and 253c) storing addresses of web pages containing one of video data, audio data, tone ring data, or image data.

If the string does not comprise a web page address, the string is further processed by the keyword analyzer 213.

The keyword analyzer 213 determines whether the string comprises any of the category notations, and if so, extracts at least one keyword from the string. The keyword can comprise a Chinese character, an English character, a numeric, or other character type.

If the string comprises any of the category notations, at least one of the databases 253a, 253b, and 253c is selected according to the table stored in the storage device 215. The keyword and an identity of the corresponding database are then sent to the WAP server 25. After receiving the keyword and an identity of the corresponding database, the search module 251 performs a search operation to search the designated database for addresses of web pages containing the keyword.

If the string does not comprise any of the category notations, the keyword is then sent to the WAP server 25. After receiving the keyword, the search module 251 performs a search operation to search all available databases (such as databases 253a, 253b, and 253c) for addresses of web pages containing the keyword. The search results are sent to the web page filter 255 for further processing.

The result of the search operation is filtered through the web page filter 255, thereby addresses of redundant web pages are filtered out. The filtered result is then sent to the assemble module 257.

The assemble module 257 assembles the filtered result. When the filtered result specifies address of one web page, the assemble module 257 generates the corresponding web page, and transmits the web page to the embedded device 21. The WAP browser 217 receives and displays the web page. When the filtered result specifies addresses of a plurality of web pages, the assemble module 257 generates a web page with a list of specified web page addresses, and transmits the web page to the embedded device 21. The WAP browser 217 then receives and displays the web page received from the assemble module 257.

FIG. 3 is a schematic view of another embodiment of the embedded device and the WAP server, wherein the input information is further processed by the WAP server before using it to perform a search operation. In FIG. 3, network is omitted for simplicity.

The embedded device 31 comprises an address field analyzer 311 and a WAP browser 317. In order to further process the input information, the WAP server 35 comprises a search module 351, a keyword analyzer 352, a storage device 354, databases 353a, 353b, and 353c, web page filter 355, and an assemble module 357.

The address field analyzer 311 analyzes a string input into an address field, wherein the address field is provided by a WAP browser 317 for receiving and presenting an address corresponding to a web page. For example, the address field analyzer 311 determines whether the string comprises a web page address. This can be done by checking whether the string comprises data having a format of a web page address.

If the string comprises a web page address, the string is transmitted to the WAP server 35. A web page corresponding to the address is retrieved from the network according to the address.

If the string does not comprise a web page address, the string is sent to the WAP server 35 and is further processed by the keyword analyzer 352 with or without referring to data stored in the storage device 354.

The storage device 354 stores information specifying a corresponding relationship between a category notation and a data type. For example, the storage device 354 stores a table specifying a plurality of category notations, each of which corresponds to the database (such as the databases 353a, 353b, and 353c) storing addresses of web pages containing one of video data, audio data, tone ring data, or image data.

The keyword analyzer 352 determines whether the string comprises any of the category notations, and if so, extracts at least one keyword from the string. The keyword can comprise a Chinese character, an English character, a numeric, or other character type.

If the string comprises any of the category notations, at least one of the databases 353a, 353b, and 353c is selected according to the table stored in the storage device 354. The keyword and an identity of the corresponding database are then sent to the search module 351. After receiving the keyword and an identity of the corresponding database, the search module 351 performs a search operation to search the designated database for addresses of web pages containing the keyword.

If the string does not comprise any of the category notations. The keyword is then sent to the search module 351. After receiving the keyword, the search module 351 performs a search operation to search all available databases (such as databases 353a, 353b, and 353c) for addresses of web pages containing the keyword. The search results are sent to the web page filter 355 for further processing.

The result of the search operation is filtered through the web page filter 355, thereby addresses of redundant web pages are filtered out. The filtered result is then sent to the assemble module 357.

The assemble module 357 assembles the filtered result. When the filtered result specifies an address of one web page, the assemble module 357 generates the corresponding web page, and transmits the web page to the embedded device 31. The WAP browser 317 receives and displays the web page. When the filtered result specifies a plurality of web pages, the assemble module 357 generates a web page with a list of specified web page addresses, and transmits the web page to the embedded device 31. The WAP browser 317 receives and displays the web page received from the assemble module 357.

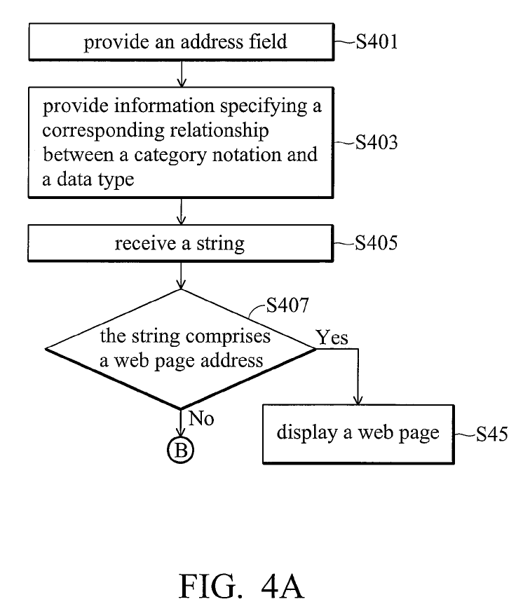

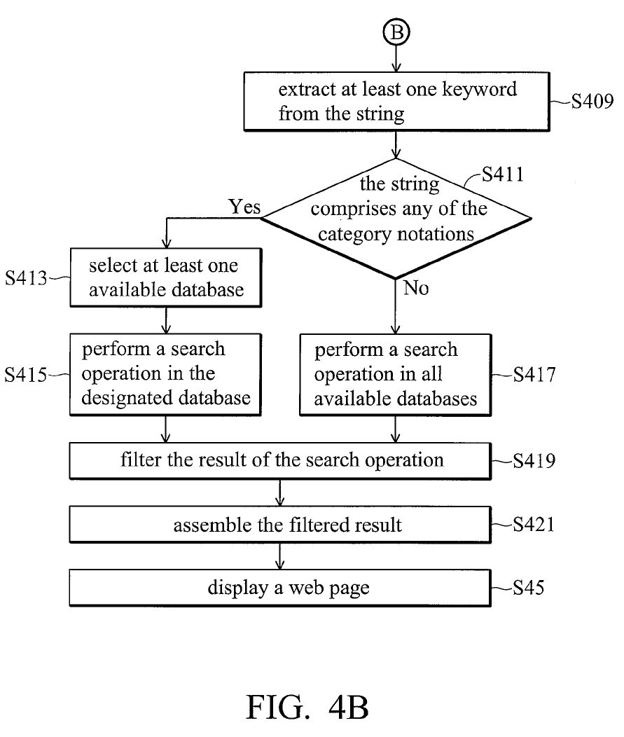

FIGS. 4A and 4B show a flowchart of an embodiment of a method of accessing a network from an embedded device. The method of FIG. 4 can be implemented in the system of FIG. 2 or FIG. 3.

An address field is provided (step S401), wherein the address field can be provided by a WAP browser. For example, the address field is provided by a WAP browser for receiving and presenting an address corresponding to a web page.

In step S403, information is provided in advance, specifying a corresponding relationship between a category notation and a data type. For example, a table is provided, specifying a plurality of category notations, each of which corresponds to the database storing addresses of web pages containing one of video data, audio data, tone ring data, or image data.

In step S405, a string is received through the address field. In step S407, it is determined whether the string comprises a web page address, and if so, the method proceeds to step S45, otherwise to step S409. Step S407 can be done by checking whether the string comprises data having a web page address format.

If the string comprises a web page address, the web page corresponding to the address is retrieved from the network according to the address (step S45).

If the string does not comprise a web page address, at least one keyword is extracted from the string (step S409) The keyword can comprise a Chinese character, an English character, a numeric, or other character type. In step S411, it is determined whether the string comprises any of the category notations. If the string comprises any of the category notations, at least one of the available databases is selected according to the information provided in step S403 (step S413). In step S415, a search operation is performed to search the designated database for addresses of web pages containing the keyword.

If the string does not comprise any of the category notations, a search operation is performed to search all available databases for addresses of web pages containing the keyword (step S417).

In step S419, the result of the search operation is filtered, thereby addresses of redundant web pages are filtered out.

The filtered result is further assembled in step S421. When the filtered result specifies an address of one web page, the corresponding web page is generated, and the web page is transmitted to the WAP browser. When the filtered result specifies addresses of a plurality of web pages, a web page with a list of specified web page addresses is generated, and the web page is transmitted to the WAP browser.

In step S45, the web page is displayed.

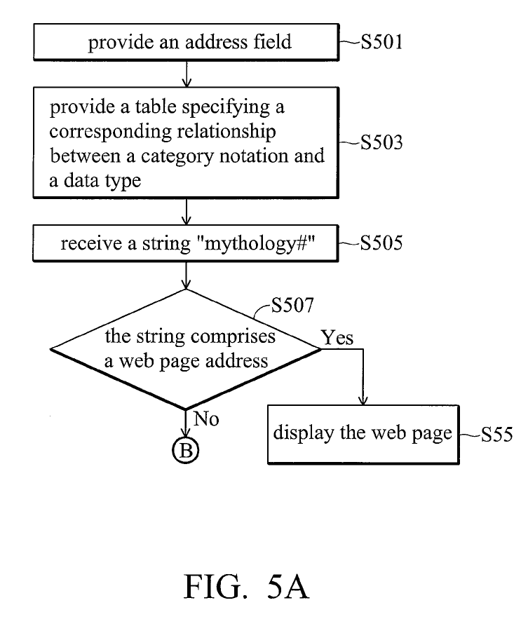

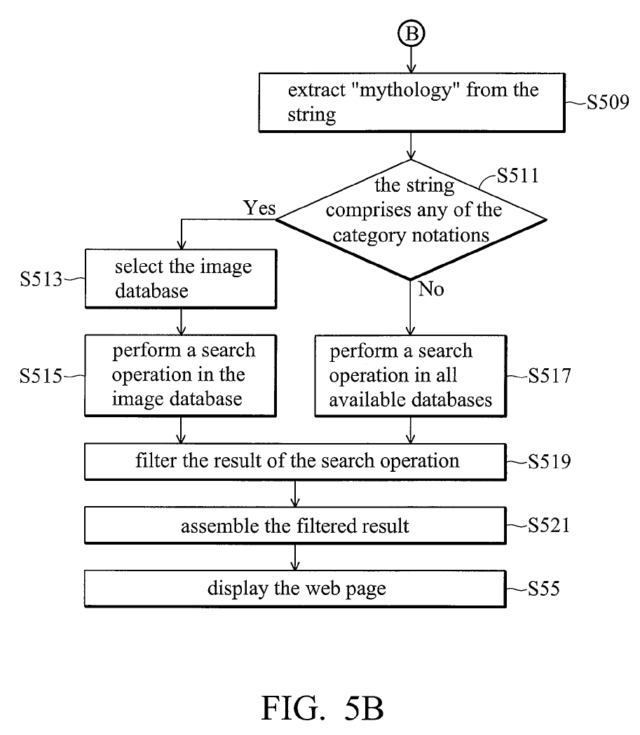

FIGS. 5A and 5B illustrate a flowchart of an embodiment of a method of accessing a network from an embedded device. The method of FIGS. 5A and 5B show an exemplary embodiment of FIGS. 4A and 4B, and can be implemented in the system of FIG. 2 or FIG. 3.

An address field is provided by a WAP browser (step S501). In step S503, a table is provided in advance, specifying a corresponding relationship between a category notation and a data type. For example, the table specifies a plurality of category notations, each of which corresponds to the database storing addresses of web pages containing one of video data, audio data, tone ring data, or image data. The category notations can be a symbol, such as “%”, “!”, and “#” According to this embodiment, the table specifies that the database for video data corresponds to category notation “%”; the database for tone ring data corresponds to category notation “!”; and the database for image data corresponds to category notation “#”.

In step S505, a string “mythology#” is received through the address field. In step S507, it is determined whether the string comprises a web page address, and if so, the method proceeds to step S55, otherwise to step S509. Step S507 can be performed by checking whether the string comprises data having a web page address format.

The string “mythology#” does not comprise a web page address according to the format thereof. At least one keyword, such as the “mythology” is extracted from the string (step S509).

In step S511, it is determined whether the string comprises any of the category notations. Here, the string comprises the category notation “#”. Accordingly, the image database is selected according to the information provided in step S503 (step S513). In step S515, a search operation is performed to search the designated database (image database) for addresses of web pages containing the keyword.

If the string does not comprise any of the category notations, a search operation is performed to search all available databases for addresses of web pages containing the keyword (step S517).

In step S519, the result of the search operation is filtered, thereby addresses of redundant web pages are filtered out.

The filtered result is further assembled in step S521. When the filtered result specifies an address of one web page, the corresponding web page is generated, and the web page is transmitted to the WAP browser. When the filtered result specifies a plurality of web pages, a web page with a list of specified web page addresses is generated, and the web page is transmitted to the WAP browser.

In step S55, the web page is displayed.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of accessing a network from an embedded device, comprising:
providing information specifying corresponding relationship between at least one category notation and at least one data type;
receiving a string;
extracting at least one keyword from the string; and
extracting a category notation from the string;
wherein addresses of web pages containing the keyword are searched from a database storing addresses of web pages containing the data type corresponding to the category notation.

2. The method of claim 1, further providing a table specifying a plurality of category notations, each of which corresponds to the database storing addresses of web pages containing one of video data, audio data, tone ring data, or image data.

3. The method of claim 1, further providing at least a database storing addresses of web pages comprises data corresponding to the category notation.

4. The method of claim 1, further filtering out addresses of duplicated web pages from the searched addresses of web pages.

5. The method of claim 4, further assembling the filtered addresses of web pages, displaying addresses of the searched web pages.

6. An embedded device connecting to a server via a network, comprising:
a user interface receiving a string;
a storage unit storing information specifying a corresponding relationship between at least one category notation and at least one data type; and
a processor extracting at least one keyword from the string and extracting a category notation from the string, wherein addresses of web pages containing the keyword are searched from a database storing addresses of web pages containing the data type corresponding to the category notation.

7. The embedded device of claim 6, wherein the storage unit further storing a table specifying a plurality of category notations, each of which corresponds to the database storing addresses of web pages containing one of video data, audio data, tone ring data, or image data.

8. The embedded device of claim 6, wherein the server filters out addresses of duplicated web pages from the addresses of web pages located thereby.

9. The embedded device of claim 8, wherein the server assembles the filtered addresses of web pages to direct the user interface of the embedded device to display addresses of the searched web pages.

10. A server providing web search service to an embedded device, comprising:
an interface receiving a string from the embedded device;
a storage unit storing information specifying corresponding relationship between at least one category notation and at least one data type;
and
a processor extracting at least one keyword from the string and extracting a category notation from the string, wherein addresses of web pages containing the keyword are searched from a database storing addresses of web pages containing the data type corresponding to the category notation.

11. The server of claim 10, wherein the storage unit further storing a table specifying a plurality of category notations, each of which corresponds to the database storing addresses of web pages containing one of video data, audio data, tone ring data, or image data.

12. The server of claim 10, wherein the processor further filters out addresses of duplicated web pages from the addresses of web pages located by the searching.

13. The server of claim 12, wherein the processor further assembles the filtered addresses of web pages to direct the embedded device to display addresses of the searched web pages.
